(19) United States
(12) Patent Application Publication
(10) Pub. No.: US 2015/0257973 A1
(43) Pub. Date: Sep. 17, 2015

(54) Automatic Spa Water Level Management and Drain ByPass System

(71) Applicant: Ralph P. Beyer, Windsor, CA (US)

(72) Inventor: Ralph P. Beyer, Windsor, CA (US)

(21) Appl. No.: 14/620,622

(22) Filed: Feb. 12, 2015

Related U.S. Application Data
(60) Provisional application No. 61/952,513, filed on Mar. 13, 2014.

(51) Int. Cl. A61H 33/00

(52) U.S. Cl. CPC A61H 33/0087

(57) ABSTRACT

A kit for cleaning a spa or hot tub that, when connected with the standard spa equipment, automatically shuts down the water pump and spa heating system to protect the spa equipment from damage, drains the dirty water from the spa using a submersible pump, automatically shuts down the submersible pump when the hot tub is empty to protect the submersible pump from damage, refills the spa with fresh water to the desired level, and restores the water pump and heating system to standard operation.

### CROSS-REFERENCES TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of the Invention

The present invention relates generally to fluid handling control systems. More specifically, the present invention relates to a system that automatically drains and refills a spa or hot tub while protecting the spa equipment from damage.

2. Description of the Related Art

Spas or Hot Tubs are a popular element of many homes and are particularly popular in rental units in resort or vacation areas. After use of the hot tub by renters, however, landlords must drain and refill the hot tub with fresh water to ensure cleanliness for the next guest. The currently available spa control systems do not have an automated method to clean the spa. First, the operator must somehow drain the water from the tub. If there is no drain in the tub itself, they must use a submersible pump or buckets to empty the tub. And then refill the tub using a garden hose or other fresh water source. If they opt to use a submersible pump for draining, the operator must remember to turn off all power to the spa controls prior to draining and must remain present throughout the draining because the pump can be damaged if it is operated for any period of time after the water has drained from the spa. In addition, the operator must remain present while the hot tub is being re-filled to ensure the appropriate water level is not exceeded, and to re-start the heating elements to bring the spa to a comfortable temperature. This makes the process quite cumbersome for a landlord due to the extensive time required. The present invention seeks to address these issues by providing an automated system whereby the operator can simply start a timer and then leave the spa unattended while the system automatically turns off all power to the spa controls, drains the spa, refills it, and re-starts the heating system so the spa is ready for use without further monitoring or action.

### BRIEF SUMMARY OF THE INVENTION

The object of the present invention is a kit which includes a Spa Control Float Switch, a Fill Control Float Switch, and an Electrical Control Unit (ECU) that can be easily hooked up to an existing commercially available home hot tub or spa, and its method of operation with the addition of a Submersible Pump and a Solenoid Valve. The ECU consists of a 120V GFCI Electrical Receptacle, a 24V Transformer, Relays, and a Timer Switch.

Standard spa equipment includes a Control Pad for operator input and a Low Voltage Spa Control System (LVSC) that controls a heating unit and a pumping system. To install the present invention, the two Float Switches are physically installed at the desired water level for full fill of the spa. The Spa Control Float Switch is electrically connected to the existing LVSC and the ECU. The Fill Control Float Switch is electrically connected to the Solenoid Valve through the ECU and to the LVSC. The Submersible Pump is placed in the tub and plugged into the 120V GFCI Electrical Receptacle that is included in the ECU. The Solenoid Valve is plumbed to the fresh water supply and electrically connected to the ECU.

The cleaning cycle is started by turning on the Timer Switch. While the Timer Switch is operating, the ECU supplies power to the 120V GFCI Electrical Receptacle which turns on the Submersible Pump, removing water from the tub. When the water falls below the optimal fill level as detected by the Spa Control Float Switch, the ECU turns off the existing spa heating unit and pumping system by disabling the LVSC. This protects the existing spa equipment from damage during the draining process. The Submersible Pump continues to pump water out of the spa until the Timer Switch times out. After the Timer Switch times out, the ECU provides power to the Solenoid Valve to open the fresh water source and fill the spa. When the spa is filled to the desired water level as detected by the Fill Float Switch, the ECU turns of power to the Solenoid Valve to stop the in-flow of water, and reapplies power to the LVSC to re-start the spa heating unit and existing pump system to restore temperature to the desired setting.

### BRIEF DESCRIPTION OF THE SEVERAL VIEWS OF THE DRAWINGS

A more complete understanding of the present invention may be derived by referring to the detailed description and claims when considered in connection with the figures, wherein like reference numbers refer to similar items throughout the figures and:

FIG. 1 is a schematic of the kit as installed wherein the spa, spa controls, and water level are shown in dashed lines, the water flow is shown with thick arrows, and the electrical connections between components are shown in thin lines;

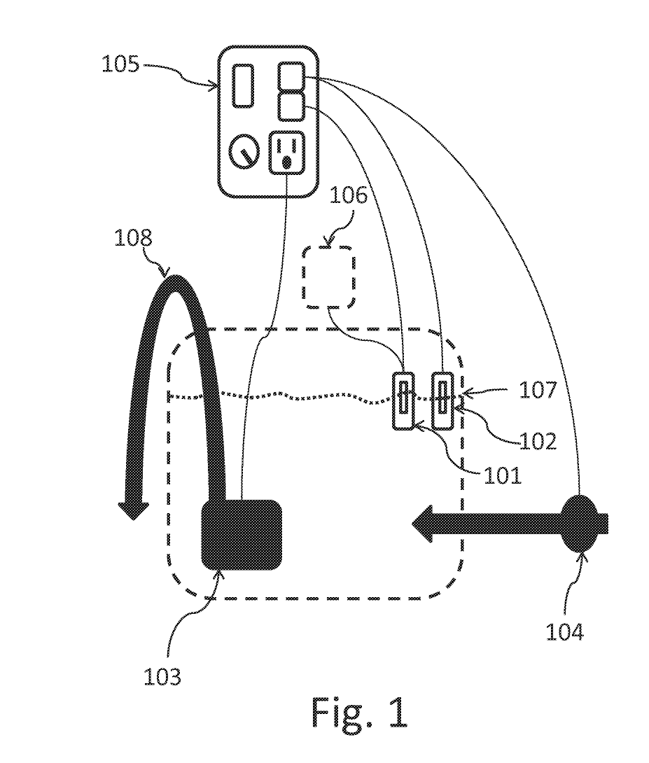

FIG. 2 is a schematic of the Electrical Control Unit identifying its components;

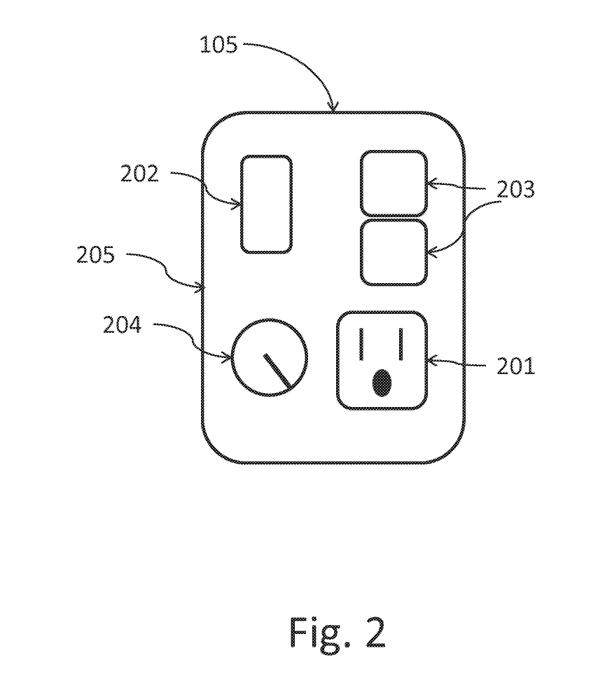

FIG. 3 is an electrical schematic of the kit as connected, and

FIG. 4 is a flow chart depicting the method.

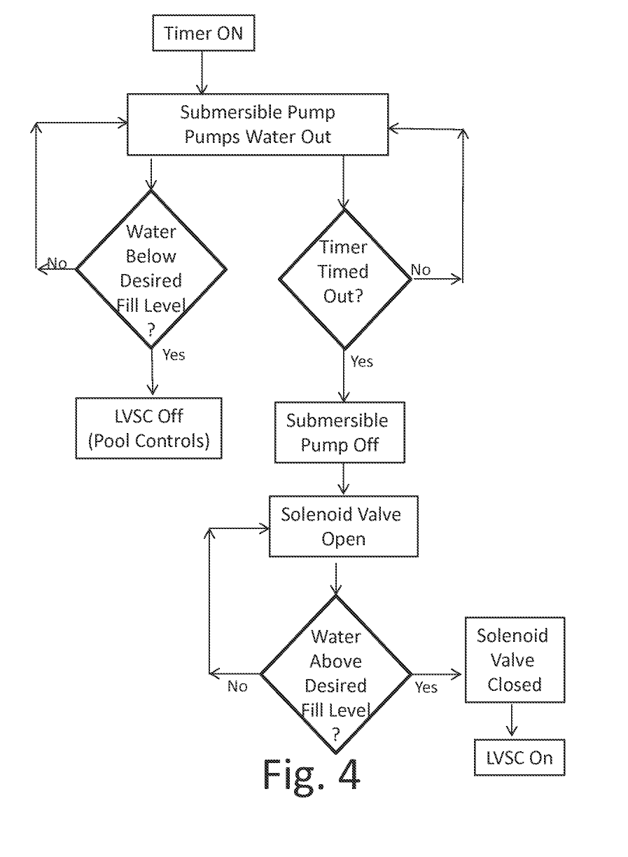

### DETAILED DESCRIPTION OF THE INVENTION

In the following detailed description of the invention, reference is made to the accompanying drawings which form a part of the disclosure and, which show by way of illustration, and not of limitation, specific embodiments by which the invention may be practiced. The drawings, the foregoing discussion, and the following description are exemplary and explanatory only, and are not intended to limit the scope of the invention or its application in any manner.

The kit includes a Spa Control Float Switch 101, a Fill Control Float Switch 102, and an Electrical Control Unit (ECU) 105. A Submersible Pump 103 which includes a Drainage Hose 108, and a Solenoid Valve 104 are also required to execute operation, and these elements may be included in the kit or, more preferably, they would be provided by the end user. The following is a detailed description of each of these elements and how they are connected for the cleaning operation.

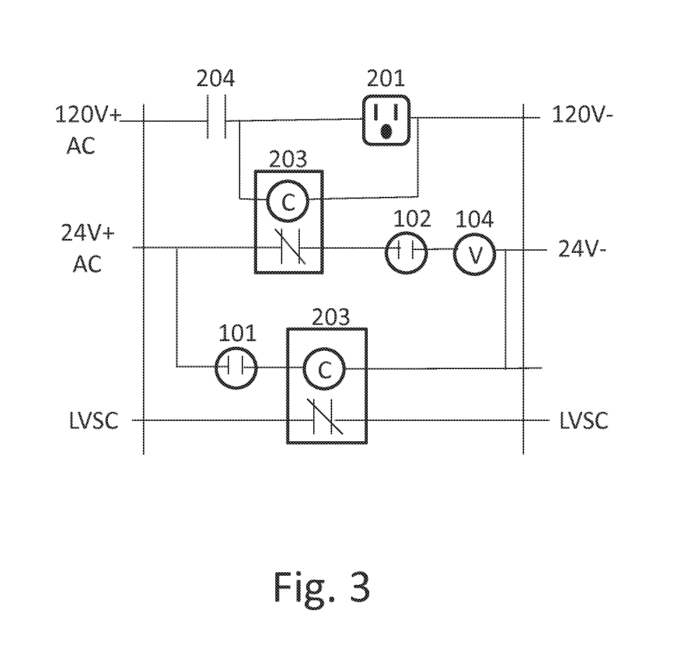

The ECU 105 includes a Housing 205, a 120V GFCI Electrical Receptacle 201, a 24V transformer 202, Relays 203, and a Timer Switch 204. Please refer to FIG. 3 for an electrical schematic of the connection of the electronic devices relative to each other and the other components of the invention. The Housing 205, is a container suitable for holding the electronic connection components and may be of any suitable shape, size and material to accommodate all components. The Timer Switch 204 is set to the appropriate time that will be required to drain the spa tub. That time will depend on the spa tub capacity, the specific Submersible Pump 103 specifications, and the size of the Drainage Hose 108.

The Submersible Pump 103 is a commercially available pump such as the Wayne ⅙ HP Submersible Utility Pump, Model #TSC160 or similar. The Submersible Pump 103 is installed at the bottom of the spa tub with the Drainage Hose 108 positioned to remove water to a suitable draining area. The Submersible Pump 103 is plugged into the standard 120V Gal Electrical Receptacle 201 in the ECU 105. It is recommended that a standard Ground Fault Circuit Interrupter (GFCI), not shown, be used with this plug to ensure the safety of the operator.

The Float Switches 101 and 102, are commercially available water level detection switches. They are mounted at the desired fill level 107 for the spa such that they will detect when the water falls below the desired fill level 107.

The Spa Control Float Switch 101 is electrically connected to the existing Low Voltage Spa Controls (LVSC) 106 such that when the Spa Control Float Switch 101 detects the water level to be below the desired fill level 107, the LVSC 106 circuit is disconnected and power to the spa heating and pumping system is turned off. This protects the existing spa equipment from damage by ensuring it is turned off during the cleaning operation.

The Solenoid Valve 104 is a commercially available valve such as Sloan ETF370A ASM Solenoid Valve Model #0305849PK or similar. It is physically plumbed to a fresh water source and electrically connected to the Relays 203 in the ECU 105.

The Fill Control Float Switch 102 is electrically connected through the ECU 105 to the Solenoid Valve 104 such that when it detects that the desired fill level 107 is achieved, it turns off power to the Solenoid Valve 104.

The following is a description of the operation of the apparatus. To start the cleaning operation, the operator turns on the Timer Switch 204, and power is supplied to the Submersible Pump 103 through the 120V GFCI Electrical Receptacle 201. The Submersible Pump 103 begins to pump water out of the spa tab. When the water falls below the desired fill level 107, the Spa Control Float Switch 101 disconnects the circuit to the LVSC 106 and the existing spa heating and pumping systems are turned off. When the Timer Switch 204 times out, power to the 120V GFCI Electrical Receptacle 201 is terminated, and the Submersible Pump 103 is turned off and power to the Solenoid Valve 104 is turned on. This protects the Submersible Pump 103 from damage, stops the draining process, and starts the inflow of fresh water to refill the spa tub. When the Fill Control Float Switch 102 detects that the water is at the desired fill level 107, the power to the Solenoid Valve 104 is turned off and the circuit to the LVSC 106 is completed. This closes off the fresh water supply and re-starts the heating and pump system for the spa to return it to normal operation.

Many modifications and variations of this invention may be made without departing from its spirit and scope, as will be appreciated by those skilled in the art. For example, the entire kit could be supplied by the manufacturer of new spa equipment and integrated within the spa control system with only minor modifications. With such an integrated option, a low water level detection switch could be used in place of the Timer Switch to terminate operation of the Submersible Pump or close a drain at the bottom of the spa tub. The embodiment as described herein was chosen and described in order to best explain the principles of the invention and its practiced applications.

I claim:

1. A kit for cleaning a hot tub used with a solenoid valve connected to a water source and a submersible pump, comprising:
a control unit electrically connected to the solenoid valve, the control unit comprising:
(i) a housing;
(ii) an electrical receptacle into which the electrical cord of the submersible pump is plugged;
(iii) a transformer;
(iv) a plurality of relays; and
(v) a timer switch, the timer switch electrically connected to the electrical receptacle such that it selectively turns power on to the electrical receptacle when operating and selectively turns power off to the electrical receptacle when it times out;
(b) a first float switch, the first float switch electrically connected to the hot tub controls and the control unit, and physically mounted at the desired fill level of the hot tub such that it selectively switches power off to the hot tub controls when the timer is operating and when detecting that the water level falls below the desired fill level, and selectively switching power on to the hot tub controls when detecting the water level is at or above the desired fill level;
(c) a second float switch, the second float switch electrically connected to the electrical control unit, and physically mounted at the desired fill level of the hot tub such that it selectively switches power on to the solenoid valve when the timer times out and the submersible pump is off, and selectively switches power off to the solenoid valve when it detects the water is at or above the desired fill level;

2. The kit of claim 1 further comprising the submersible pump and the solenoid valve.

3. An automated timer-controlled hot tub cleaning method utilizing a submersible pump, a first float switch, a second float switch, a solenoid valve connected to a fresh water source, and a control unit comprising the steps of: turning on a timer where the time period of the timer is sufficient for the submersible pump to empty water from the hot tub; turning on the submersible pump to start emptying water from the hot tub; when the water falls below the desired fill level as detected by the first float switch, turning off the hot tab controls; when the timer has timed out, turning off the submersible pump to stop emptying water and turning on the solenoid valve to start filling the hot tub with fresh water; when the water reaches the desired fill level as detected by the second float switch, turning off the solenoid valve to stop filling the hot tub with water and turning on the hot tub controls.
